(19) United States
(12) Patent Application Publication
(10) Pub. No.: US 2024/0303612 A1
(43) Pub. Date: Sep. 12, 2024

(54) METHOD AND SYSTEM FOR FACILITATING TRUSTLESS PAYMENT TRANSACTIONS USING SMART CONTRACTS

(71) Applicant: Mastercard International Incorporated, Purchase, NY (US)

(72) Inventors: Mark Ziade, New York, NY (US); Issidor L. Iliev, White Plains, NY (US)

(73) Assignee: Mastercard International Incorporated, PURCHASE, NY (US)

(21) Appl. No.: 18/598,160

(22) Filed: Mar. 7, 2024

Related U.S. Application Data
(60) Provisional application No. 63/451,394, filed on Mar. 10, 2023.

(51) Int. Cl. G06Q 20/06; G06Q 20/40; H04L 9/00

(52) U.S. Cl. CPC G06Q 20/065; G06Q 20/401; H04L 9/50; G06Q 2220/00; H04L 2209/56

(57) ABSTRACT

A method for processing a trustless blockchain transfer via a card payment network includes: storing, in a blockchain associated with a blockchain network, a smart contract configured to control an amount of blockchain currency in the blockchain; receiving, by a blockchain node in the blockchain network, an authorization request message from a first computing system, where the blockchain nodes submits the authorization request message as input to the smart contract; receiving, by a blockchain node, an authorization response message from a second computing system, where the blockchain nodes submits the authorization response message as input to the smart contract; and executing, by a blockchain node, the smart contract in the blockchain causing the smart contract to (i) verify the authorization request message and authorization response message, and (ii) transfer at least a portion of the amount of blockchain currency to a predetermined blockchain address.

### FIELD

The present disclosure relates to the processing of trustless payment transactions via the use of card networks and blockchains, specifically the use of blockchain smart contracts to provide for a trustless blockchain transfer from a consumer while enabling a merchant to receive fiat or other currency.

### BACKGROUND

Blockchain transactions were started as an alternative to the use of fiat currency for the technologically savvy, where a distributed and decentralized network was used to track the transactions. Blockchain currency, also referred to as cryptocurrency, started at a relatively small value and has since exploded in worth due to more widespread use and significant investment and trading. Users are generally met with two options for use of blockchain currency: a self-custodial wallet where the user controls the private key of their blockchain wallet and performs transactions themselves, or a custodied wallet where a third party controls a user's private key and handles transactions on behalf of the user. In both instances, transactions are conducted between two blockchain wallets to exchange blockchain currency. Some blockchain networks offer the ability to convert currency or utilize a swap, where a first currency is transferred from one party and the other party receives a second currency. However, these processes are very difficult for the average consumer to utilize and are often subject to wildly varying exchange rates and fees.

At the same time, consumers are very familiar and comfortable with the use of payment cards for payment transactions. However, there are a lack of systems for enabling a consumer to utilize blockchain currency in a transaction conducted with a payment card. Additionally, many merchants are still wary of or uninterested in receiving blockchain currency as payment. As such, a consumer that wishes to utilize blockchain currency in a payment transaction with a merchant must overcome the technical difficulties of using a blockchain wallet as well as only transacting with merchants that are willing to accept that same blockchain currency as payment.

Thus, there is a need for a technological solution for the facilitation of payment transactions on a card network that provides convenience and familiarity for consumers while still enabling merchants to receive fiat currency for the transaction.

### SUMMARY

The present disclosure provides a description of systems and methods for processing a trustless blockchain transfer via a card payment network. A consumer registers with a card issuer that provides a payment card that is linked to a smart contract that is added to the blockchain for the blockchain currency the consumer wishes to use for a transaction, where the smart contract is funded via the consumer's blockchain wallet. The consumer can present the payment card to a merchant for a payment transaction, where the merchant reads payment details therefrom and initiates processing of the transactions using traditional methods. During processing, the payment transaction is routed to a processor that identifies the use of the blockchain-linked payment card. The processor provides the authorization request for the transaction to the smart contract as well as the card issuer. The card issuer approves the transaction (e.g., if the equivalent amount of blockchain currency is covered by the funding) and sends an authorization response message to the smart contract. The smart contract verifies that the authorization request and response match and that the transaction is approved, and then executes to transfer the appropriate amount of blockchain currency to the card issuer on the blockchain. The card issuer, receiving the payment in blockchain currency from the consumer, makes a payment of the amount of fiat currency (e.g., or other currency as requested by the merchant) to the merchant using traditional processes. The result is that a consumer can use a payment card and make payment via blockchain currency regardless of the merchant's acceptance of blockchain currency, and the merchant receives fiat payment for a card transaction without any change to existing processes. Furthermore, the transaction is trustless for the consumer, as the funds are controlled by a smart contract and can only be transferred with a legitimate and authorized transaction initiated by the consumer via the payment card.

A method for processing a trustless blockchain transfer via a card payment network includes: storing, in a blockchain associated with a blockchain network, a smart contract configured to control an amount of blockchain currency in the blockchain; receiving, by a receiver of one of a plurality of blockchain nodes in the blockchain network, an authorization request message from a first computing system, where the one of the plurality of blockchain nodes submits the authorization request message as input to the smart contract; receiving, by the receiver of the one of the plurality of blockchain nodes, an authorization response message from a second computing system, where the one of the plurality of blockchain nodes submits the authorization response message as input to the smart contract; and executing, by the one of the plurality of blockchain nodes, the smart contract in the blockchain, wherein execution of the smart contract causes the smart contract to (i) verify both the authorization request message and authorization response message, and (ii) transfer at least a portion of the amount of blockchain currency to a predetermined blockchain address.

A system for processing a trustless blockchain transfer via a card payment network includes: a blockchain network associated with a blockchain, the blockchain network including a plurality of blockchain nodes, and the blockchain storing a smart contract configured to control an amount of blockchain currency in the blockchain; a first computing system; and a second computing system, wherein one of the plurality of blockchain nodes receives an authorization request message from the first computing system, where the one of the plurality of blockchain nodes submits the authorization request message as input to the smart contract, the one of the plurality of blockchain nodes receives an authorization response message from the second computing system, where the one of the plurality of blockchain nodes submits the authorization response message as input to the smart contract, and the one of the plurality of blockchain nodes executes the smart contract in the blockchain, wherein execution of the smart contract causes the smart contract to (i) verify the authorization request message and authorization response message, and (ii) transfer at least a portion of the amount of blockchain currency to a predetermined blockchain address.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for processing trustless payment transactions via a card network and blockchain network in accordance with exemplary embodiments.

FIG. 2 is a block diagram illustrating a computing system in the system of FIG. 1 for processing trustless payment transactions via a card network and blockchain network in accordance with exemplary embodiments.

FIGS. 3A and 3B are a flow diagram illustrating a process for performing a trustless payment transaction via a card network and blockchain network in the system of FIG. 1 in accordance with exemplary embodiments.

FIG. 4 is a flow chart illustrating an exemplary method for processing trustless payment transactions via a card network and blockchain network in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Processing Trustless Payment Transactions

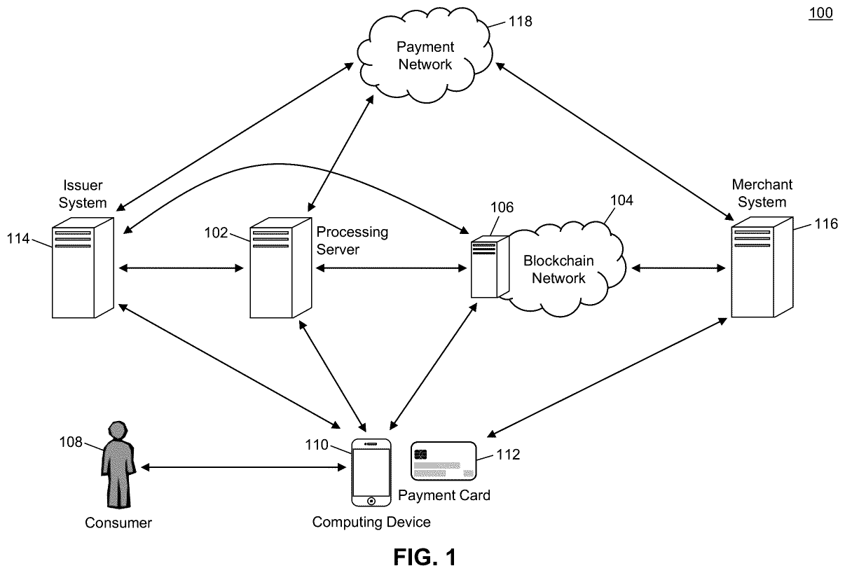

FIG. 1 illustrates a system 100 for the processing of a trustless payment transaction via the use of a payment card that utilizes a payment network and blockchain network through a smart contract.

The system 100 can include a processing server 102. The processing server 102, discussed in more detail below, can be configured to facilitate trustless payment transactions that are conducted via the use of a payment card 112, payment network 118, and blockchain network 104.

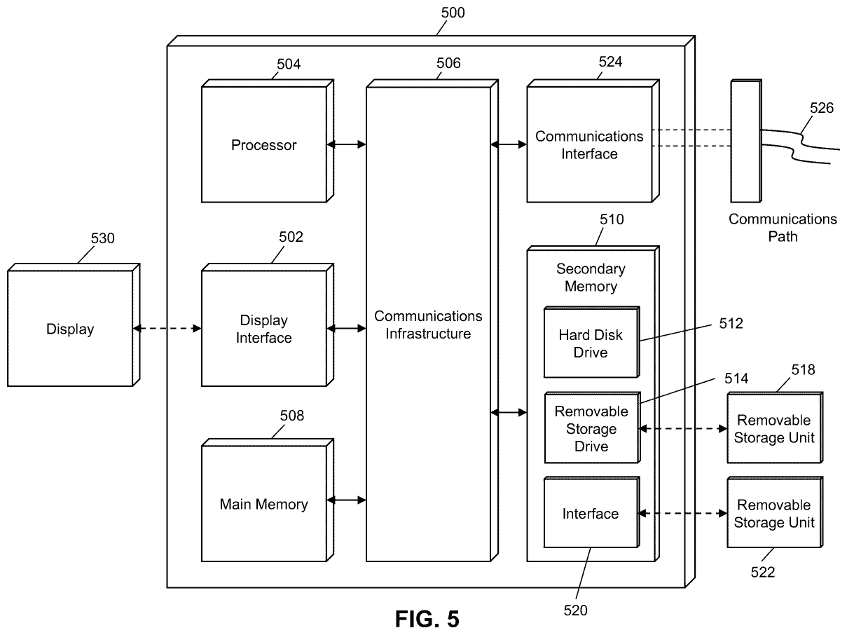

The blockchain network 104 can be comprised of a plurality of blockchain nodes 106. Each blockchain node 106 can be a computing system, such as illustrated in FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated, and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in the blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” can refer specifically to the private key. In other cases, the term “blockchain wallet” can refer to a computing device (e.g., computing device 110, etc.) that stores the private key for use thereof in blockchain transactions. For instance, each computing device can each have their own private key for respective cryptographic key pairs, and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., a computing device 110) that is generated using the sender's private key, a blockchain address of the recipient of currency (e.g., an issuer system 114) generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in the blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

As discussed herein, blockchain currency can refer to any asset that can be stored on a blockchain and transferred through the use of a blockchain transaction. Blockchain currency can include any cryptographic currency, stablecoins (e.g., blockchain currency tied to a fiat currency or other asset), non-fungible token, digital token, fiat currency as stored on a blockchain, etc. In some cases, the blockchain currencies utilized in the system 100 can depend on what is accepted by the issuer system 114, capabilities of the blockchain network 104, desires of the consumer 108, and/or criteria of the processing server 102.

The system 100 can also include a payment network 118. A payment network 118 can be a system or network used for the transfer of money via the use of cash-substitutes for thousands, millions, and even billions of transactions during a given period. Payment networks can use a variety of different protocols and procedures in order to process the transfer of money for various types of transactions. Transactions that can be performed via a payment network can include product or service purchases, credit purchases, debit transactions, fund transfers, account withdrawals, etc. Payment networks can be configured to perform transactions via cash-substitutes, which can include payment cards, letters of credit, checks, transaction accounts, etc. Examples of networks or systems configured to perform as payment networks include those operated by Mastercard©, VISA®, Discover®, American Express®, PayPal©, etc. Use of the term “payment network” herein can refer to both the payment network as an entity, and the physical payment network, such as the equipment, hardware, and software comprising the payment network, which are also known as “payment rails.”

As used herein, “payment card” can refer to a card, which can be a physical card or a virtual card, which can be presented to a merchant for use of the associated account in funding a payment transaction. In some cases, the term payment card can refer to a digital token provisioned to a computing device 110 that is used for payment transactions. In an exemplary embodiment, a payment card 112 can be provisioned to a consumer 108 via by an issuer system 114.

The issuer system 114 can be associated with an issuer, which can be an entity that establishes (e.g., opens) a letter or line of credit in favor of a beneficiary, and honors drafts drawn by the beneficiary against the amount specified in the letter or line of credit. In many instances, the issuer can be a bank or other financial institution authorized to open lines of credit. In some instances, any entity that can extend a line of credit to a beneficiary may be considered an issuer. The line of credit opened by the issuer can be represented in the form of a payment account, and may be drawn on by the beneficiary via the use of the payment card 112.

Traditionally, the consumer 108 can use their issued payment card 112 to fund a payment transaction with a merchant system 116 (e.g., via a point of sale or other interface of the merchant system 116) with a fiat currency via the associated transaction account. As used herein, “payment transaction” can refer to a transaction between two entities in which money or other financial benefit is exchanged from one entity to the other. The payment transaction can be a transfer of funds, for the purchase of goods or services, for the repayment of debt, or for any other exchange of financial benefit as will be apparent to persons having skill in the relevant art. In some instances, payment transaction can refer to transactions funded via a payment card 112 and/or payment account, such as credit card transactions. Such payment transactions can be processed via an issuer system 114, payment network 118, and acquirer. The process for processing such a payment transaction can include at least one of authorization, batching, clearing, settlement, and funding. Authorization can include the furnishing of payment details by the consumer 108 to the merchant system 116, the submitting of transaction details (e.g., including the payment details) from the merchant system 116 to their acquirer, and the verification of payment details with the issuer system 114 of the consumer's payment account used to fund the transaction. Batching can refer to the storing of an authorized transaction in a batch with other authorized transactions for distribution to an acquirer. Clearing can include the sending of batched transactions from the acquirer to a payment network 118 for processing. Settlement can include the debiting of the issuer by the payment network 118 for transactions involving beneficiaries of the issuer. In some instances, the issuer can pay the acquirer via the payment network 118. In other instances, the issuer can pay the acquirer directly. Funding can include payment to the merchant from the acquirer for the payment transactions that have been cleared and settled. It will be apparent to persons having skill in the relevant art that the order and/or categorization of the steps discussed above performed as part of payment transaction processing.

In the system 100, the consumer 108 can be interested in using their blockchain wallet stored on the computing device 110 for payment in a payment transaction conducted with the merchant system 116. However, the merchant system 116 can be interested in receiving payment via traditional process and with fiat currency. In order to facilitate such a transaction, the consumer 108 can apply for a payment card 112 from an issuer system 114 that is willing to accept payment from consumers via blockchain currency. The consumer 108 can request a payment card 112 from the issuer system 114 for a specific amount of blockchain currency, and can provide authorization for such a transfer from their blockchain wallet via suitable means, such as providing a digital signature, their public key, one or more unspent transaction outputs, etc. The issuer system 114 can receive the request and, if acceptable, issue a payment card 112 to the consumer 108 (e.g., as a physical card, virtual card or digital token to the computing device 110, etc.) and generate a smart contract that is associated with that payment card 112. The smart contract can be supplied to a blockchain node 106 in the blockchain network 104 and be configured to transfer blockchain currency from the consumer 108 to the issuer system 114 only when an authorized payment transaction has been conducted with the payment card 112. In some cases, the smart contract can transfer funds controlled by the blockchain wallet of the computing device 110. In other cases, the smart contract can itself be funded. In such cases, the smart contract can operate a blockchain wallet, where the consumer 108 transfers the specified amount of blockchain currency to the smart contract. In these cases, the consumer 108 can perform additional transactions to increase the funding of the smart contract. In such an instance, the payment card 112 can be used for multiple payment transactions using the methods discussed herein as long as the consumer 108 provides sufficient funding to cover the additional payment transactions.

In some embodiments, the smart contract can be generated by another component in the system 100, such as the processing server 102, a blockchain node 106, or a third party system. In some cases, the functionality of the smart contract can be predetermined such that the configuration of the smart contract is the same regardless of which component generates the smart contract, which can further enable any component in the system 100 to generate the smart contract. In some instances, the smart contract can be verified by another component in the system 100 after generation before it is added to the blockchain. For instance, the issuer system 114 can generate the smart contract, which can be provided to the consumer 108 via the computing device 110 for verification and approval prior to being added to the blockchain. In another example, the issuer system 114 can supply the relevant information for the smart contract (e.g., destination address, funding information from the consumer 108, etc.) to a blockchain node 106, which can generate the smart contract and add it to the blockchain using traditional methods and systems.

In some cases, the smart contract can include an identifier, which can be provided by the issuer system 114 or provided by the blockchain node 106, such as where the smart contract identifier can be a transaction identifier for the blockchain data value that includes the smart contract. In such cases, the smart contract identifier can be included in communications related to the smart contract, such as transaction messages, as discussed below. In some instances, the issuer system 114 can provide the smart contract identifier to the computing device 110 such that the consumer 108 can verify that the smart contract is correct and added to the blockchain.

The blockchain node 106 can add the smart contract to the blockchain network 104 using traditional methods and systems. Once the smart contract is added to the blockchain and the consumer 108 has received the payment card 112, the consumer 108 can use the payment card 112 at a merchant system 116 for payment for a payment transaction. The merchant system 116 (e.g., via a point of sale device, web page, application program, etc.) can read payment details from the payment card 112. The payment card 112 can include payment details similar to a traditional payment card used for credit card transactions conducted with fiat currency, such as an account number, security code, expiration date, name, billing address, etc. The merchant system 116 can read or otherwise receive the appropriate payment details from the payment card 112 and include the payment details in an authorization request generated for the new payment transaction.

An authorization request can be a transaction message that is submitted from a merchant and routed to a payment network 118 for processing. In some cases, transaction messages discussed herein can be specially formatted according to one or more standards governing the exchange of financial transaction messages, such as the International Organization of Standardization's ISO 8583 or ISO 20022 standards. In these cases, payment details and other transaction data can be stored in specific data elements included in a transaction message. Transaction messages can also include a message type indicator, one or more bitmaps, or other data as specified in the applicable standard(s). In such cases, an authorization request can be a transaction message with a message type indicator that indicates an authorization request.

The authorization request can include at least the payment details, which includes at least the account number from the payment card 112, a merchant identification number, transaction amount, and any other data suitable for use in processing a payment transaction, such as a transaction time and/or date, currency identifier, point of sale identifier, acquirer identification value, issuer identification value, etc. The merchant system 116 can (e.g., directly or via one or more intermediary systems, such as an acquirer) submit the authorization request to the payment network 118 via payment rails associated therewith. The payment network 118 can receive the authorization request and route the authorization request based on at least the account number included in the payment details. A portion of the account number can serve as a bank identification number or other value that is associated with an entity that is authorized to process transactions for which the associated payment card 112 is used. As a result, the payment network 118 can parse the account number from the authorization request and forward the authorization request to the processing server 102 using the payment rails of the payment network 118.

The processing server 102 can receive the authorization request and initiate processing thereof. In the system 100, the processing server 102 can be a separate system and/or entity from other components in the system 100. In some cases, the processing server 102 can be a part of another system and/or entity in the system 100, such as being a part of the payment network 118, also serving as a blockchain node 106 in the blockchain network 104, etc. In some cases, the processing server 102 can be a part of the issuer system 114. In other cases, the processing server 102 can be separate from any issuer system 114 to maintain trustlessness in use of the blockchain currency used to fund the smart contract.

Once the processing server 102 receives the authorization request, the processing server 102 can determine that the authorization request is for a payment transaction that is funded via a blockchain-linked payment card 112. The processing server 102 can identify that the payment card 112 used in the payment transaction was issued by the issuer system 114, such as based on the account number, a portion thereof, or other data included in the authorization request. The processing server 102 can identify the smart contract that is associated with the payment card 112, such as by using the account number, portion thereof, or other value included in the transaction message (e.g., the smart contract identifier), and electronically transmit the authorization request to a blockchain node 106 in the blockchain network 104 for submission as input to the smart contract. The processing server 102 can also forward the authorization request to the issuer system 114 using a suitable communication network and method.

The issuer system 114 can receive the authorization request and perform a process to determine of the payment transaction should be approved or declined. The issuer system 114 can identify the payment card 112 used in the payment transaction using the data included in the authorization request and determine if the transaction amount for the payment transaction is covered by the funding amount for the smart contract. If the smart contract does not have access to enough funds to cover the payment transaction, the issuer system 114 can decline the payment transaction using traditional methods. If the smart contract is funded a sufficient amount to cover the new payment transaction, the issuer system 114 can approve the transaction. The issuer system 114 can generate an authorization response message for the payment transaction, which can be a transaction message that includes a message type indicator that is indicative of an authorization response message. In some cases, the authorization response message can be a new transaction message. In other cases, the issuer system 114 can modify the message type indicator in the authorization request to convert the authorization request to an authorization response.

The authorization response can include a data value that indicates that the transaction is approved. The issuer system 114 can electronically transmit the authorization response to a blockchain node 106 in the blockchain network 104, where the blockchain node 106 can submit the authorization response as input to the smart contract. The issuer system 114 can also forward the authorization response to the payment network 118 via the payment rails thereof, either directly or via the processing server 102. The payment network 118 can forward the authorization response back to the merchant system 116 via the payment rails thereof (e.g., directly or via one or more intermediary systems, such as an acquirer). The merchant system 116 can identify that the payment transaction was approved, and provide the transacted-for goods or services to the consumer 108.

In the blockchain, once the smart contract has received both the authorization request and authorization response as input, the smart contract can verify that the messages match to ensure that the transaction was processed by the authorized processing server 102 and issuer system 114. The smart contract can verify that the payment details in both messages match the payment card 112, that other transaction data in both messages match (e.g., merchant identifier, transaction amount, transaction time and/or date, etc.), and can verify any other data included in the transaction messages as necessary. For example, in some cases, the issuer system 114 can be configured to add additional data in the authorization response that is only known to the issuer system 114, to ensure successful verification. For instance, the smart contract can be generated with a public key and the issuer system 114 can digitally sign the authorization response with the corresponding private key, where the smart contract can verify the digital signature with the public key to ensure that the authorization response is coming from the genuine issuer system 114. In another example, a transaction identifier or other identification value can be shared between the processing server 102 and issuer system 114 for transactions involving the payment card 112, where the processing server 102 can include the value in the authorization request submitted into the smart contract and the issuer system 114 can include the value in the authorization response submitted into the smart contract, where the smart contract can verify the existence and equivalence of both values. In some cases, the smart contract can be configured to receive transaction messages as formatted for transmission via the payment rails of the payment network 118. In other cases, the transaction messages can be converted prior to being supplied to the smart contract as input. Such conversion can be performed by the blockchain node 106 or other suitable system. In some cases, such other suitable system, often referred to as an “Oracle,” can be used to facilitate communications between components in the system 100, such as to convert transaction messages for input into smart contracts, convert data when transmitted between the processing server 102 and issuer system 104, standardize data for use in performing the functions discussed herein, etc. In some embodiments, the Oracle can be responsible for supplying the authorization request and response messages (e.g., or data included therefrom if reformatted) as the input into the smart contract.

Once the authorization request and response messages have been successfully verified by the smart contract, the smart contract can self-execute to transfer the appropriate amount of blockchain currency to the blockchain wallet associated with the issuer system 114 or other blockchain wallet as indicated in the smart contract (e.g., supplied by the issuer system 114 when generating the smart contract). The transfer can be accomplished in a new blockchain transaction that is generated by the smart contract and confirmed and added to the blockchain using traditional methods. In some cases, the smart contract can be configured to transmit notification messages regarding the successful verification and/or transfer, which can be transmitted to the issuer system 114, processing server 102, and/or computing device 110.

Once the blockchain transaction has been completed and the blockchain currency transferred from the smart contract to the issuer system 114, the issuer system 114 can initiate payment of fiat currency to the merchant system 116 using traditional methods. In some instances, the payment of fiat currency by the issuer system 114 can utilize a payment processing network, such as operated by MasterCard©, where the issuer system 114 can pay the payment processing network and the payment processing network can pay the merchant system 116. In cases where the merchant system 116 is interested in receiving payment via other currency, the issuer system 114 can facilitate such payment using suitable payment methods. In such cases, the authorization request submitted by the merchant system 116 can specify the currency requested for payment and where the transaction amount in the authorization request can be the amount in the desired currency. The result is that the consumer 108 can make a payment via a payment card 112 using their desired blockchain currency, while a merchant system 116 can receive payment in their desired currency without any modification to existing systems and processes.

In cases where the consumer 108 uses a stablecoin that is tied to the same fiat currency received by the merchant system 116, the processes discussed above can be performed without any currency exchanges or conversions. In cases where the blockchain currency used by the consumer 108 has a different value to the fiat currency received by the merchant, the equivalent amounts of each currency can be identified during the processes discussed above. In an example, the processing server 102 can receive the authorization request from the payment network 118 that includes a transaction amount in the fiat currency requested by the merchant system 116. The processing server 102 can calculate the equivalent amount in the blockchain currency, which can be a set value, specified in the smart contract, based on known exchange rate data, etc. The processing server 102 can provide this amount to the issuer system 114 as part of the authorization request (e.g., in a data element reserved for private use) or separate to the authorization request in the same transmission or a separate transmission. In another example, the issuer system 114 can perform the calculation. In an exemplary embodiment, the exchange rate between the fiat currency and the blockchain currency can be stored in the smart contract to further maintain the trustless nature of the transaction for the consumer 108.

In some embodiments, the processing server 102 can be configured to generate the account numbers used in payment cards 112 in the system 100. In such embodiments, when the issuer system 114 wants to generate a new payment card 112 for a consumer 108, the issuer system 114 can use an account number provided by the processing server 102 (e.g., prior to the generation of the payment card 112 or upon request by the issuer system 114 when generating the payment card 112). In some cases, the processing server 102 can have a bank identification number associated therewith that is provided to the issuer system 114 for inclusion in the account number. In such embodiments, supplying of the account number or bank identification number by the processing server 102 can ensure routing of authorization requests to the processing server 102 by the payment network 118. Additionally, the processing server 102 can be configured to perform functions discussed herein for a plurality of different issuer systems 114, which can enable multiple entities to issue payment cards 112 to consumers 108 for use in the processes discussed herein.

In some embodiments, blockchain transactions can be provided by the processing server 102 and issuer system 114 to the smart contract instead of transaction messages for the card payment transaction. In such embodiments, once the processing server 102 receives the authorization request, the processing server 102 can generate a blockchain transaction for the transfer of the blockchain currency from the smart contract to the destination address, and can electronically transmit the blockchain transaction to the blockchain node 106 for input into the smart contract. The issuer system 114 can likewise generate the blockchain transaction for the transfer of the blockchain currency from the smart contract to the destination address upon receipt of the authorization request from the processing server 102 and provide the new blockchain transaction to the blockchain node 106 for input into the smart contract. The smart contract can perform its verification by verifying that the two received blockchain transactions are accurate (e.g., the correct destination address and other transaction data) and the same.

In other embodiments, the verification of the authorization request and authorization response discussed above can be performed by a different component than the smart contract, such as the processing server 102, issuer system 114, or a third party system. In such embodiments, the component can perform the verification, as discussed above, and, if successful, generate the new blockchain transaction for the transfer of the appropriate amount of blockchain currency from the smart contract to the issuer system 114. The new blockchain transaction can be submitted as input to the smart contract via a blockchain node 106, which can verify the accuracy of the new blockchain transaction and have the new blockchain transaction added to the blockchain upon execution of the smart contract.

In some instances, a smart contract can be configured to use aggregation to perform less transfers to an issuer system 114, such as in cases where a payment card 112 can be used for multiple transactions. In such an instance, the smart contract can perform the verification process discussed above, and, if successful, provide a notification message to the processing server 102 and/or issuer system 114, but refrain from initiating a new blockchain transaction. The smart contract can perform the same actions for additional payment transactions and can aggregate the transaction amounts for each of the payment transactions. When triggered, the smart contract can initiate a single new blockchain transaction for payment of the aggregate amount to the issuer system 114 or other destination address. The smart contract can be triggered using any suitable method, such as periodically (e.g., daily, weekly, etc.), when the transaction amount exceeds a predetermined value, upon request from the issuer system 114, etc.

The methods and systems discussed herein provide for trustless payment transactions that can be conducted using a payment card and traditional card processing, but where the consumer 108 funds the payment transaction via a blockchain currency and the merchant system 116 receives payment via fiat currency or other currency as desired. The use of a smart contract ensures that the transaction is trustless, where the consumer 108 can be assured that only a transaction that they themselves initiate and is processed by the appropriate systems will be successfully processed. Additionally, the consumer 108 can use any currency they want at any merchant without regard for the acceptance rules of the merchant, and can do so using a familiar and trusted payment card system. Furthermore, merchant systems 116 can receive payment using their desired currency and without any modification to existing systems and processes, while enabling their consumers 108 to pay with any currency they want provided a payment card 112 is used. The result is a technologically advanced system that greatly benefits both consumers 108 and merchant systems 116.

### Computing System

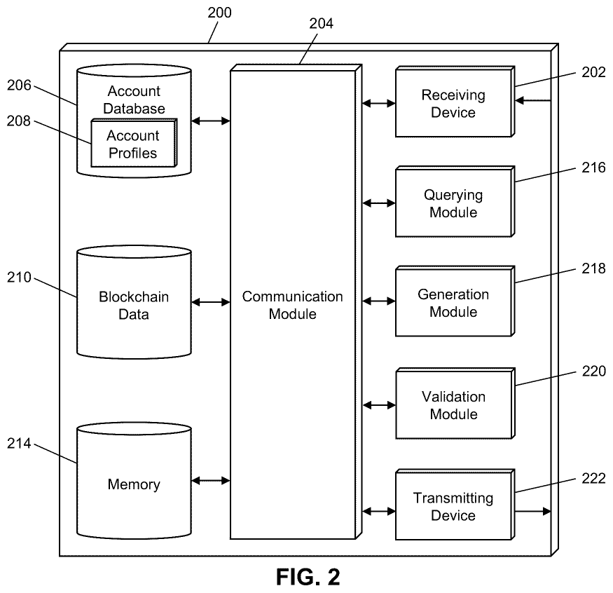

FIG. 2 illustrates an embodiment of the computing system 200 in the system 100 of FIG. 1. It will be apparent to persons having skill in the relevant art that the embodiment of the computing system 200 illustrated in FIG. 2 is provided as illustration only and cannot be exhaustive to all possible configurations of the computing system 200 suitable for performing the functions as discussed herein. For example, the computer system 500 illustrated in FIG. 5 and discussed in more detail below can be a suitable configuration of the computing system 200. In some cases, components of the system 100, such as the processing server 102, blockchain nodes 106, issuer system 114, merchant system 116, and computing device 110, can include the components illustrated in FIG. 2 and discussed below.

The computing system 200 can include a receiving device 202. The receiving device 202 can be configured to receive data over one or more networks via one or more network protocols. In some instances, the receiving device 202 can be configured to receive data from processing servers 102, blockchain nodes 106, computing devices 110, issuer systems 114, merchant systems 116, payment networks 118, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by processing servers 102 that can be superimposed or otherwise encoded with transaction messages, authorization requests, bank identification numbers, account numbers, transaction amounts, notification messages, etc. The receiving device 202 can also be configured to receive data signals electronically transmitted by blockchain nodes 106 that can be superimposed or otherwise encoded with blockchain data, transaction identifiers, smart contract data, cryptographic keys, notification messages, etc. The receiving device 202 can also be configured to receive data signals electronically transmitted by computing devices 110, which can be superimposed or otherwise encoded with registration data, payment details, cryptographic keys, digital signatures, account balances, etc. The receiving device 202 can also be configured to receive data signals electronically transmitted by issuer systems 114, which can be superimposed or otherwise encoded with payment card data, digital tokens, notification messages, smart contract data, blockchain data, cryptographic keys, etc. The receiving device 202 can also be configured to receive data signals electronically transmitted by merchant systems 114 and payment networks 118 that can be superimposed or otherwise encoded with transaction messages, authentication data, destination addresses, cryptographic keys, payment details, etc.

The computing system 200 can also include a communication module 204. The communication module 204 can be configured to transmit data between modules, engines, databases, memories, and other components of the computing system 200 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the computing system 200 and external components of the computing system 200, such as externally connected databases, display devices, input devices, etc. The computing system 200 can also include a processing device. The processing device can be configured to perform the functions of the computing system 200 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The computing system 200 can also include an account database 206. The account database 206 can be configured to store one or more account profiles 208 using a suitable data storage format and schema. The account database 206 can be a relational database that utilizes structured query language for the storage, identification, modifying, updating, accessing, etc. of structured data sets stored therein. Each account profile 208 can be a structured data set configured to store data related to a computing device 110, consumer 108, payment card 112, issuer system 114, etc. An account profile 208 can store account numbers, bank identification numbers, issuer system 114 identification information, smart contract data, etc. For example, a processing server 102 can store account profiles 208 for each issuer system 114 where the account profile 208 includes all account numbers for which authorization requests should be routed to that issuer system 114.

The computing system 200 can also include blockchain data 210, which can be stored in a memory 214 of the computing system 200 or stored in a separate area within the computing system 200 or accessible thereby. The blockchain data 210 can include a blockchain, which may be comprised of a plurality of blocks and be associated with the blockchain networks 104 and a core blockchain. In some cases, the blockchain data 210 can further include any other data associated with the blockchain and management and performance thereof, such as block generation algorithms, digital signature generation and confirmation algorithms, communication data for blockchain nodes 106, smart contracts, cryptographic keys, etc. The blockchain data 210 can also include data used by the computing system 200 for actions associated with a blockchain, such as cryptographic key pairs for blockchain wallets, public keys for generating destination addresses or validating digital signatures, transaction histories, cryptocurrency amounts, etc.

The computing system 200 can also include a memory 214. The memory 214 can be configured to store data for use by the computing system 200 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the computing system 200 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, network identifiers, payment details, blockchain wallet data, transaction messaging data, exchange rate information, transaction amount data, smart contract data, etc.

The computing system 200 can include a querying module 216. The querying module 216 can be configured to execute queries on databases to identify information. The querying module 216 can receive one or more data values or query strings and can execute a query string based thereon on an indicated database, such as the memory 214 of the computing system 200 to identify information stored therein. The querying module 216 can then output the identified information to an appropriate engine or module of the computing system 200 as necessary. The querying module 216 can, for example, execute a query on the account database 206 to identify an account profile 208 associated with an account number included in a received authorization request for use in forwarding that authorization request to the appropriate processing server 102 or issuer system 114.

The computing system 200 can also include a generation module 218. The generation module 218 can be configured to generate data for use by the computing system 200 in performing the functions discussed herein. The generation module 218 can receive instructions as input, can generate data based on the instructions, and can output the generated data to one or more modules of the computing system 200. For example, the generation module 218 can be configured to generate data messages, notification messages, response messages, cryptographic keys, blockchain transactions, blockchain data values, digital signatures, smart contracts, transaction messages, authorization responses, converted currency amounts, authentication requests, etc.

The computing system 200 can also include a validation module 220. The validation module 220 can be configured to perform validations for the computing system 200 as part of the functions discussed herein. The validation module 220 can receive instructions as input, which can also include data to be used in performing a validation, can perform a validation as requested, and can output a result of the validation to another module or engine of the computing system 200. The validation module 220 can, for example, be configured to validate digital signatures, authenticate registration data, validate compliance of a transaction message with established criteria, verify transaction messages, verify transaction amounts, verify smart contract data, etc.

The computing system 200 can also include a transmitting device 222. The transmitting device 222 can be configured to transmit data over one or more networks via one or more network protocols. In some instances, the transmitting device 222 can be configured to transmit data to processing servers 102, blockchain nodes 106, computing devices 110, issuer systems 114, merchant systems 116, payment networks 118, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to processing servers 102 that are superimposed or otherwise encoded with account numbers, payment details, transaction messages, notification messages, account number requests, bank identification number requests, etc. The transmitting device 222 can also be configured to electronically transmit data signals to blockchain nodes 106 that can be superimposed or otherwise encoded with requests for blockchain data, requests for smart contract data, validation requests, new blockchain transactions, smart contracts, smart contract input data, cryptographic keys, authorization requests, authorization responses, etc. The transmitting device 222 can also be configured to electronically transmit data signals to computing devices 110, which can be superimposed or otherwise encoded with confirmation messages, transaction identifiers, cryptographic keys, data requests, notification messages, destination addresses, transaction amounts, etc. The transmitting device 222 can also be configured to electronically transmit data signals to issuer systems 114, which can be superimposed or otherwise encoded with payment card requests, authorization requests, transaction messages, account numbers, bank identification numbers, notification messages, etc. The transmitting device 222 can also be configured to electronically transmit data signals to merchant systems 114 and payment networks 118 that can be superimposed or otherwise encoded with payment details, transaction amounts, authorization requests, authorization responses, transaction messages, notification messages, account number requests, transaction data, etc.

### Process for a Trustless Payment Transaction

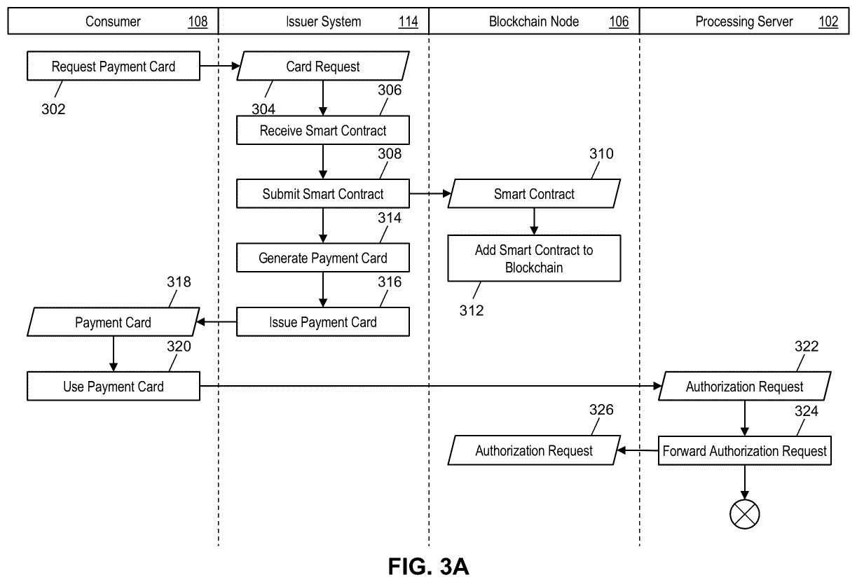

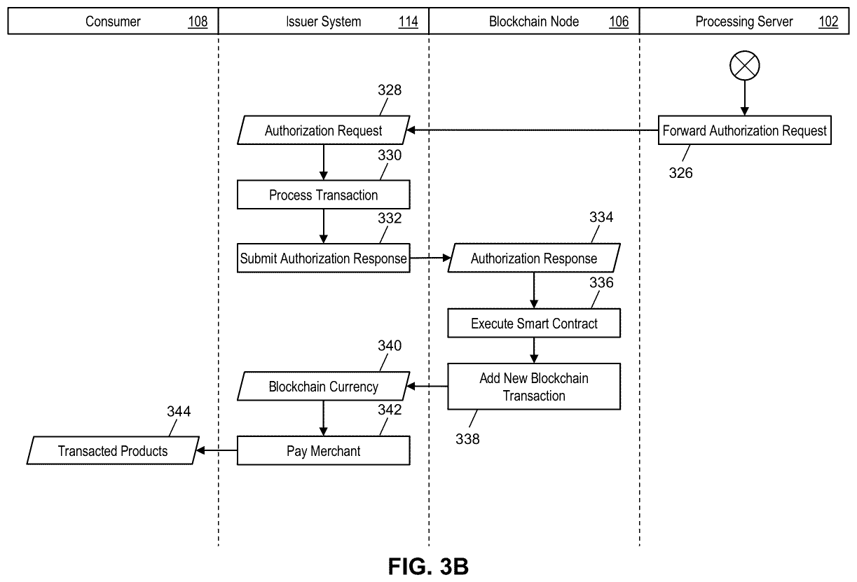

FIGS. 3A and 3B illustrates a process for a trustless payment transaction conducted using a card network and blockchain in the system 100 of FIG. 1.

In step 302, the consumer 108 can (e.g., via their computing device 110) request a payment card 112 from the issuer system 114 by a submission made using a suitable communication network and method, such as can be transmitted by a transmitting device 222 of the computing device 110. In step 304, a receiving device 202 of the issuer system 114 can receive the payment card request. The payment card request can specify a blockchain currency, requested funding amount, and provide any other necessary details. In step 306, a receiving device 202 of the issuer system 114 can receive a new smart contract for the requested payment card 112, which can be received upon request from a third party system following a submission of relevant data thereto by the issuer system 114 (e.g., of the destination address, payment details of the requested payment card 112, etc.). The new smart contract can include a destination address of a blockchain wallet of the issuer system 114, payment details for the requested payment card 112, and any other data suitable for performing the functions discussed herein. In step 308, a transmitting device 222 of the issuer system 114 can electronically transmit the smart contract to a blockchain node 106 in the blockchain network 104 using a suitable communication network and method. In some cases, the payment card request can include a blockchain transaction for funding the smart contract. In other cases, the consumer 108 can, via their computing device 110, submit one or more new blockchain transactions to a blockchain node 106 in the blockchain network 104 to fund the smart contract.

In step 310, a receiving device 202 of the blockchain node 106 can receive the smart contract from the issuer system 114. In step 312, the blockchain node 106 can add the smart contract to the blockchain associated with the blockchain network 104 using traditional methods. In step 314, a generation module 218 of the issuer system 114 can generate the new payment card 112, which can include the payment details included in the generated smart contract. In some cases, the payment details can include a bank identification number previously provided to the issuer system 114 by the processing server 102. In step 316, the issuer system 114 can issue a payment card 112 to the consumer 108, which can be a physical card delivered to the consumer 108 or a virtual card or digital token electronically transmitted to the consumer 108 (e.g., via their computing device 110 from a transmitting device 222 of the issuer system 114). In step 318, the consumer 108 can receive the payment card 112 from the issuer system 114 that is linked to the smart contract added to the blockchain.

In step 320, the consumer 108 can use the payment card 112 at a merchant. The consumer 108 can use the payment card 112 in any manner in order to convey payment details to the merchant system 116, such as via magnetic strip, near field communication, integrated circuit chip, form input on a web page or application program, etc. The merchant can receive the payment details and generate an authorization request for a payment transaction that includes the payment details and a transaction amount. The merchant can then submit the authorization request to the payment network 118 via payment rails associated therewith. The payment network 118 can then route the authorization request to the processing server 102 using the account number or data included therein. In step 322, a receiving device 202 of the processing server 102 can receive the authorization request. In step 324, the processing server 102 can, via a transmitting device 222, electronically transmit the authorization request to a blockchain node 106 in the blockchain network 104 for submission into the smart contract as input thereof. In step 326, the transmitting device 222 of the processing server 102 can also electronically transmit the authorization request to the issuer system 114, which can be identified by the processing server 102 (e.g., via a querying module 214 and account profile 208) using the account number or other transaction data included in the authorization request. In cases where a currency conversion is necessary, the processing server 102 can identify the appropriate amount of blockchain currency, which can be transmitted to the issuer system 114 as part of or in addition to the authorization request.

In step 328, the receiving device 202 of the issuer system 114 can receive the authorization request. In step 330, the issuer system 114 can process the payment transaction, such as by ensuring that the appropriate amount of blockchain currency for the payment transaction is covered by the funding amount of the smart contract associated with the payment card 112 used in the payment transaction. The issuer system 114 can approve the payment transaction and generate, via a generation module 218 thereof, an authorization response for the payment transaction that indicates approval of the transaction. In step 332, the transmitting device 222 of the issuer system 114 can electronically transmit the authorization response to a blockchain node 106 in the blockchain network 104. In step 334, a receiving device 202 of the blockchain node 106 can receive the authorization response.

In step 336, the blockchain node 106 can submit the received authorization request and authorization response transaction messages into the smart contract as input, which can initiate self-execution by the smart contract. Upon execution, the smart contract can verify the authorization request and authorization response messages to ensure that the transaction is authorized, each involved entity is authenticated, and the amount of blockchain currency can be adequately transferred via the smart contract's funding. Upon successful verification, the smart contract can generate a new blockchain transaction for payment of the appropriate amount of blockchain currency to the destination address indicated in the smart contract. The new blockchain transaction can be provided to the blockchain node 106, which can, in step 338, add the new blockchain transaction to the blockchain using suitable methods.

In step 340, the issuer system 114 can receive the transferred blockchain currency in its blockchain wallet. In some cases, the blockchain node 106 can electronically transmit a notification message to the issuer system 114 to notify the issuer system 114 of the transfer. In other cases, the issuer system 114 can identify the new blockchain transaction on the blockchain to determine that the transfer was successful and the currency received. In step 342, the issuer system 114 can initiate payment of the transaction amount included in the authorization request to the merchant system 116 using traditional methods. In step 344, the consumer 108 can receive the transacted-for products from the merchant system 116, which can occur as a result of the issuer system 114 being paid blockchain currency from the consumer 108 in a trustless blockchain transaction and the merchant system 116 being paid fiat currency from the issuer system 114.

### Exemplary Method for Processing Blockchain Transactions

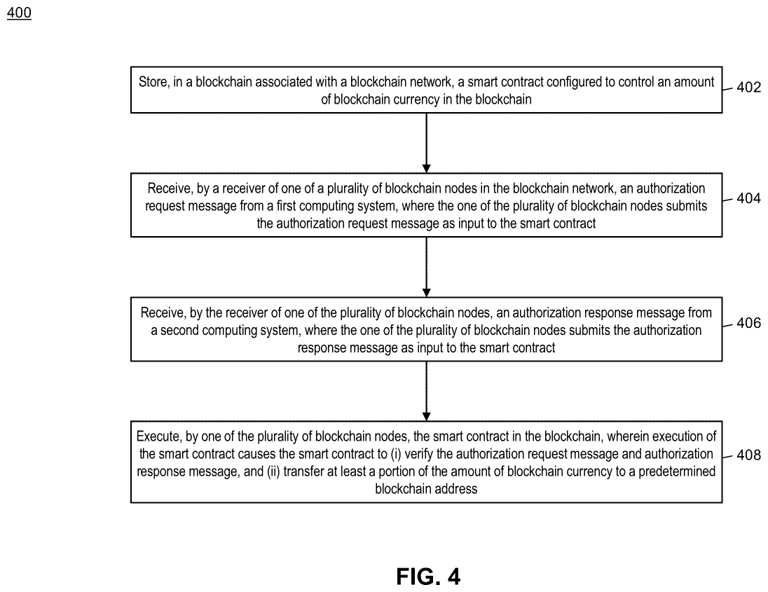

FIG. 4 illustrates a method 400 for the processing of a blockchain transaction using a payment card and a linked blockchain wallet.

In step 402, a smart contract configured to control an amount of blockchain currency in a blockchain can be stored in a blockchain associated with a blockchain network (e.g., blockchain network 104). In step 404, an authorization request message can be received by a receiver (e.g., receiving device 202) of one of a plurality of blockchain nodes (e.g., blockchain nodes 106) in the blockchain network from a first computing system (e.g., processing server 102), where the one of the plurality of blockchain nodes submits the authorization request message as input to the smart contract.

In step 406, an authorization response message can be received by the receiver of one of the plurality of blockchain nodes from a second computing system (e.g., issuer system 114), where the one of the plurality of blockchain nodes submits the authorization response message as input to the smart contract. In step 408, the smart contract in the blockchain can be executed by one of the plurality of blockchain nodes, wherein execution of the smart contract causes the smart contract to (i) verify the authorization request message and authorization response message, and (ii) transfer at least a portion of the amount of blockchain currency to a predetermined blockchain address.

In one embodiment, the predetermined blockchain address can be stored in the smart contract. In some embodiments, the method 400 can further include receiving, by the receiver of one of the plurality of blockchain nodes, the smart contract from the second computing system prior to storing the smart contract in the blockchain. In one embodiment, verifying the authorization request message and authorization response message can include comparing one or more data values included in each of the authorization request message and authorization response message. In a further embodiment, the authorization request message and authorization response message can be specially formatted according to one or more standards, the one or more data values can be stored in one or more predetermined data elements, and the one or more data values can include a transaction identifier.

In some embodiments, the authorization response message can include at least a transaction amount, and execution of the smart contract can further cause the smart contract to (iii) verify that the amount of blockchain currency is greater than or equal to the transaction amount. In one embodiment, the method 400 can also include: receiving, by the receiver of one of the plurality of blockchain nodes, a new blockchain transaction that transfers additional blockchain currency to the smart contract; and storing, in the blockchain, the new blockchain transaction, wherein the amount of blockchain currency can be increased by the additional blockchain currency. In some embodiments, the smart contract can be further configured to only transfer the amount of blockchain currency following verification of the authorization request message and the authorization response message.

### Computer System Architecture

FIG. 5 illustrates a computer system 500 in which embodiments of the present disclosure, or portions thereof, can be implemented as computer-readable code. For example, the computing device 102, blockchain nodes 105, merchant system 108, and provider system 110 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3A, 3B, and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A, 3B, and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for processing a trustless blockchain transfer via a card payment network. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for processing a trustless blockchain transfer via a card payment network, comprising:
storing, in a blockchain associated with a blockchain network, a smart contract configured to control an amount of blockchain currency in the blockchain;
receiving, by a receiver of one of a plurality of blockchain nodes in the blockchain network, an authorization request message from a first computing system, where the one of the plurality of blockchain nodes submits the authorization request message as input to the smart contract;
receiving, by the receiver of the one of the plurality of blockchain nodes, an authorization response message from a second computing system, where the one of the plurality of blockchain nodes submits the authorization response message as input to the smart contract; and
executing, by the one of the plurality of blockchain nodes, the smart contract in the blockchain, wherein execution of the smart contract causes the smart contract to (i) verify the authorization request message and authorization response message, and (ii) transfer at least a portion of the amount of blockchain currency to a predetermined blockchain address.

2. The method of claim 1, wherein the predetermined blockchain address is stored in the smart contract.

3. The method of claim 1, further comprising:
receiving, by the receiver of the one of the plurality of blockchain nodes, the smart contract from the second computing system prior to storing the smart contract in the blockchain.

4. The method of claim 1, wherein verifying the authorization request message and authorization response message includes comparing one or more data values included in each of the authorization request message and authorization response message.

5. The method of claim 4, wherein
the authorization request message and authorization response message are specially formatted according to one or more standards,
the one or more data values are stored in one or more predetermined data elements, and
the one or more data values include a transaction identifier.

6. The method of claim 1, wherein
the authorization response message includes at least a transaction amount, and
execution of the smart contract further causes the smart contract to (iii) verify that the amount of blockchain currency is greater than or equal to the transaction amount.

7. The method of claim 1, further comprising:
Page 3 of 6 receiving, by the receiver of the one of the plurality of blockchain nodes, a new blockchain transaction that transfers additional blockchain currency to the smart contract; and
storing, in the blockchain, the new blockchain transaction, wherein
the amount of blockchain currency is increased by the additional blockchain currency.

8. The method of claim 1, wherein the smart contract is further configured to only transfer the amount of blockchain currency following verification of the authorization request message and the authorization response message.

9. A system for processing a trustless blockchain transfer via a card payment network, comprising:
a blockchain network associated with a blockchain, the blockchain network including a plurality of blockchain nodes, and the blockchain storing a smart contract configured to control an amount of blockchain currency in the blockchain;
a first computing system; and
a second computing system, wherein
one of the plurality of blockchain nodes receives an authorization request message from the first computing system, where the one of the plurality of blockchain nodes submits the authorization request message as input to the smart contract,
the one of the plurality of blockchain nodes receives an authorization response message from the second computing system, where the one of the plurality of blockchain nodes submits the authorization response message as input to the smart contract, and
the one of the plurality of blockchain nodes executes the smart contract in the blockchain, wherein execution of the smart contract causes the smart contract to (i) verify the authorization request message and authorization response message, and (ii) transfer at least a portion of the amount of blockchain currency to a predetermined blockchain address.

10. The system of claim 9, wherein the predetermined blockchain address is stored in the smart contract.

11. The system of claim 9, wherein the one of the plurality of blockchain nodes receives the smart contract from the second computing system prior to storing the smart contract in the blockchain.

12. The system of claim 9, wherein verifying the authorization request message and authorization response message includes comparing one or more data values included in each of the authorization request message and authorization response message.

13. The system of claim 12, wherein
the authorization request message and authorization response message are specially formatted according to one or more standards,
the one or more data values are stored in one or more predetermined data elements, and
the one or more data values include a transaction identifier.

14. The system of claim 9, wherein
the authorization response message includes at least a transaction amount, and
execution of the smart contract further causes the smart contract to (iii) verify that the amount of blockchain currency is greater than or equal to the transaction amount.

15. The system of claim 9, wherein
the one of the plurality of blockchain nodes receives a new blockchain transaction that transfers additional blockchain currency to the smart contract,
the blockchain stores the new blockchain transaction, and
the amount of blockchain currency is increased by the additional blockchain currency.

16. The system of claim 9, wherein the smart contract is further configured to only transfer the amount of blockchain currency following verification of the authorization request message and the authorization response message.
